(19) United States
(12) Patent Application Publication
(10) Pub. No.: US 2007/0169124 A1
(43) Pub. Date: Jul. 19, 2007

(54) Method, system and program product for detecting and managing unwanted synchronization

(76) Inventors: Aaron Kershenbaum, New City, NY (US); Lawrence Koved, Pleasantville, NY (US); George B. Leeman, Ridgefield, CT (US); Darrell C. Reimer, Tarrytown, NY (US)

Correspondence Address: LAW OFFICE OF CHARLES W. PETERSON, JR. Yorktown, 11703 BOWMAN GREEN DRIVE, SUITE 100, RESTON, VA, 20190, US

(21) Appl. No.: 11/272,198

(22) Filed: Nov. 10, 2005

(51) Int. Cl. G06F 9/46; G06F 9/45

(52) U.S. Cl. 718/102; 717/144

(57) ABSTRACT

A method, system and program product for minimizing unwanted synchronizations in a multithreading program. Program functions in a multithreading program that should not be synchronized are identified as input tails, e.g., manually identified. An invocation graph is constructed for the multithreading program with nodes identified as head nodes and tail nodes that correspond to the input tails. Synchronization information is collected for each node of the invocation graph. Sources of synchronization in the invocation graph are represented as source nodes. All paths from head nodes to tail nodes through at least one source node are identified.

### BACKGROUND OF THE INVENTION

1. Field of the Invention

The present invention generally relates to the multi-threaded processors and more particularly to detecting and managing synchronization between programs in multithreaded systems.

2. Background Description

Semiconductor technology and chip manufacturing advances have resulted in a steady increase of on-chip clock frequencies, the number of transistors on a single chip, e.g., in a state of the art processor or microprocessor. A scalar processor fetches and issues/executes one instruction at a time. Each such instruction operates on scalar data operands. Each such operand is a single or atomic data value or number. Generally, unit performance for a given clocked unit increases linearly with the frequency of switching within it, provided the clocked unit is operating at full capacity. Pipelining within a scalar processor introduces what is known as concurrency, i.e., processing multiple instructions at difference pipeline stages in a given clock cycle, while preserving the single-issue paradigm. A superscalar processor can fetch, issue and execute multiple instructions in a given machine cycle, each in a different execution path or thread. Each instruction fetch, issue and execute path is usually pipelined for further, parallel concurrency. State of the art commercial microprocessors (e.g. Intel's Netburs™ Pentium™ IV or IBM's POWER5™) use a mode of multithreading that is commonly referred to as Simultaneous MultiThreading (SMT). In each processor cycle, a SMT processor simultaneously fetches instructions for different threads that populate the back-end execution resources.

Frequently, multiple programming tasks or threads are concurrently dispatched that require a common resource. Inevitably, some threads compete for the same resource and so, collide. The simplest example of such a collision occurs when multiple threads concurrently attempt to modify of the value of the same field. Occasionally, such a collision can result in what is known in the art as a race condition, where the collision causes a program failure or, even a system failure. The simplest way to avoid collisions and eliminate race conditions is through synchronization.

Synchronization routines are well known in the art for preventing collisions and eliminating potential race conditions. A typical synchronization routine forces threads to execute serially, thus losing much of the advantage of multi-threading. Unfortunately, no state of the art facility is available to programmers for determining which threads will collide and which will not. Although synchronization eliminates race conditions, because it forces serial execution, it eliminates races at the expense of overall program performance and efficiency. Consequently, programmers normally implement synchronization routines only very sparingly. Regardless, however, if the synchronization is necessary because races are inevitable, the programmer must force serial execution and accept the unavoidable efficiency and performance degradation.

For example, very large web based applications perform poorly or fail when unwanted synchronization is present, e.g., due to synchronized calls to database operations and Lightweight Directory Access Protocol (LDAP) servers. Common symptoms of unwanted synchronization include slow, erratic response times and throughput, application hangs and even, entire website outages. Further, these symptoms become apparent at the most inopportune moments, e.g., in a production environment under heavy workload. During such periods, minor hardware network or software component problems can trigger unwanted synchronization to result in more severe problems. Moreover, these problems may be difficult to simulate, e.g., during system test or normal maintenance.

Several such tools are available for detecting unnecessary synchronization in moderately complex programs, e.g., javac, javacup, pizza, jlex. These are typically of size in the order of 104 to 105 lines of source code. Usually unnecessary synchronization was detected via static analysis. Typically, however the only way to identify such unwanted synchronizations in more complex functions is with a set of sophisticated runtime analysis tools, that are both tedious and difficult to use. Further, since these tools are complicated, finding unwanted synchronizations requires a high skill level and is costly, especially in a production environment. Also, most of these tools focus only on reducing the overhead caused by the synchronization itself, i.e., the cost of performing locking and unlocking operations.

Thus, there is need for a tool for identifying potential occurrences of unwanted synchronization in code, especially prior to deploying the code in a production environment.

### SUMMARY OF THE INVENTION

It is a purpose of the invention to improve the performance of complex multithreaded systems;

It is another purpose of the invention to identify potential sources of thread synchronization;

It is another purpose of the invention to eliminate unnecessary synchronization from multithreaded code.

The present invention is related to a method, system and program product for minimizing unwanted synchronizations in a multithreading program. Program functions in a multithreading program that should not be synchronized are provided as an input and are called “tails.” All possible entry points to the program are computed, and they are called “heads.” An invocation graph is then constructed for the multithreading program, that includes “head nodes” and “tail nodes,” corresponding to the heads and tails, respectively. Synchronization information is collected for each node of the invocation graph. Sources of synchronization in the invocation graph are represented as source nodes. All paths from head nodes to tail nodes through at least one source node are identified.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows a flow diagram example of identifying thread synchronizations in multithreaded program code according a preferred embodiment of the present invention.

FIG. 2 shows a flow diagram example in more detail of the step of building the invocation graph with head nodes automatically being identified and synchronization information being collected.

FIGS. 3A-B show an example of pseudo-code for identifying synchronized objects for each basic block, each node and each edge of the invocation graph.

FIG. 4 shows a flow diagram example in more detail of the step of finding head to tail paths through sources.

### DESCRIPTION OF PREFERRED EMBODIMENTS

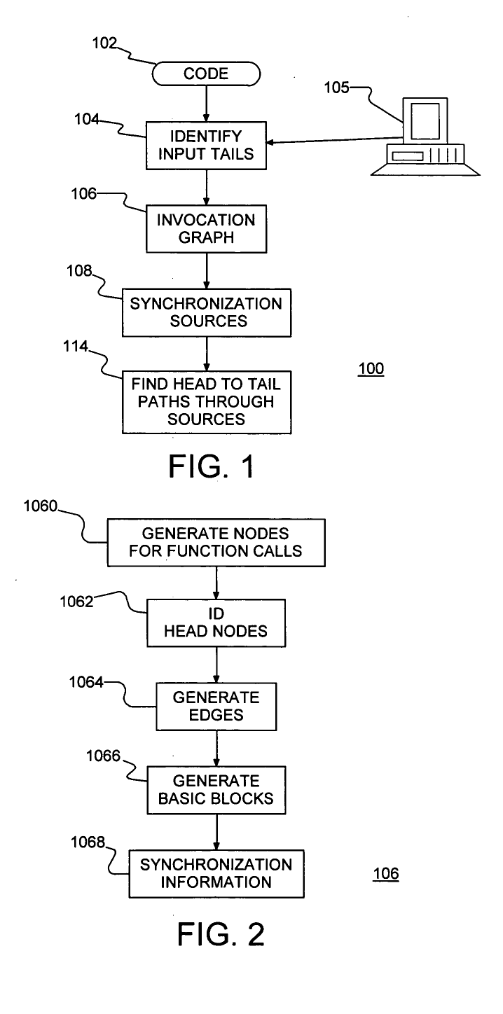

Turning now to the drawings, and more particularly, FIG. 1 shows a flow diagram example 100 of identifying thread synchronizations in multithreaded program code 102 according a preferred embodiment of the present invention. First in step 104, functions in the code are manually (e.g., at computer terminal 105) identified that should not be synchronized, e.g., because of computing expense. The identified functions are marked as input tails. Next, the code and set of input tails or tail functions are passed to step 106, where an invocation graph is built for the code. Entry points into the code are identified as head nodes and synchronization information is collected for each node. In step 108, sources of synchronization are determined for each node as described hereinbelow. Synchronization is also determined at each basic block and at each entry to a node, i.e., the node function. In block 114, all paths from each head node through any source to a given tail node are determined and provided as user output. So, for each head node h and tail node t, all paths passing through a source are identified from h to t.

Thus, unwanted synchronization in multithreaded programs is identified to determine the set of critical synchronization paths for a particular program. The code is examined to identify unwanted synchronization of a prescribed set of tail functions. All possible entry points, or head functions, are found and a determination is made whether any tail functions are in any of the execution paths from the head functions and where in the path threads are executing under the constraints of synchronization.

Beginning in step 104 input tails are manually identified as those functions with potentially time consuming execution, e.g., computationally expensive calls, system calls, or calls to remote resources. Also included as input tails are those functions that may not return from a call because of system or software failure. The input tail functions should not, if possible, be synchronized. One way to identify tail functions is to analyze execution traces of running programs. Typical examples of input tails are functions that create sockets, connect to databases, make Remote Method Invocation (RMI) calls, perform directory lookups, initiate expensive database queries, parse XML documents, or write to local files.

The tails are provided as an input to step 106, where the invocation graph is created as a collection of basic blocks using, for example, a suitable, well known technique. In the invocation graph, an edge from function p to function s means that p calls s. Grove et al., “A framework for call graph construction algorithms,” ACM Transactions on Programming Languages and Systems, 23 (6), November 2001, pp. 685-746, provide a comparison of suitable such techniques. The invocation graph represents code intraprocedural and interprocedural operation, and includes a control flow graph for each invoked function. The control flow graph represents the interprocedural invocation of each succeeding function S from a basic block B within a proceeding function P over edges (P, B, S).

Nodes are categorized as one of three types within the invocation graph, a head node, a source node or a tail node. A tail node represents an input tail and, so, a potentially time consuming function. So, two more types of nodes, head nodes and source nodes, are distinguished from the invocation graph in step 108 in addition to tail nodes. A node function that begins an execution path is designated as a head node. A head node may be a root of the graph or a head node may initiate synchronization relevant actions, e.g., the start of a new thread of execution. Although typically the head nodes are automatically identified during invocation graph construction, optionally the user may further select a subset of the head nodes. The source nodes are derived through analysis and are nodes where synchronization originates. In many monitor-based languages, source nodes arise either from synchronized functions or synchronized blocks of code.

In step 108, various identified synchronizations are analyzed, and some may be eliminated. The synchronization for a given source node may be necessary or unnecessary. A synchronization is unnecessary if removing it does not change program behavior. Otherwise, the synchronization is necessary. For example, if eliminating a synchronization causes a race condition, the synchronization is identified as necessary. Also, synchronizations that significantly degrade performance are identified as unwanted. So, unwanted synchronization may be further categorized as necessary or unnecessary. Unnecessary and unwanted synchronizations can simply be removed. The only option for eliminating necessary and unwanted synchronizations, however, is to restructure the code. Thus, it must be determined if the code could be restructured (perhaps automatically) to make identified necessary and unwanted synchronizations unnecessary.

FIG. 2 shows a flow diagram example in more detail of the step of building the invocation graph 106 with head nodes automatically being identified and synchronization information being collected. First in step 1060 a node is generated for each function call. Then, in step 1062 head nodes are iteratively identified. Each node N is checked for a predecessor node P in some basic block B of the invocation graph connected by an edge (P, B, N). Head nodes N are those nodes with no predecessors, i.e., with no edges of the form (X, B, N) for any X and any B. Optionally, some head nodes (e.g., head nodes that are not of interest) can be removed manually from the list of identified head nodes. In step 1064, edges are generated for every pair of function calls, i.e. if p calls s, then there will be an edge (p,s). Then, in step 1066 basic blocks are generated for each node. In step 1068, information is collected for all objects used for synchronization.

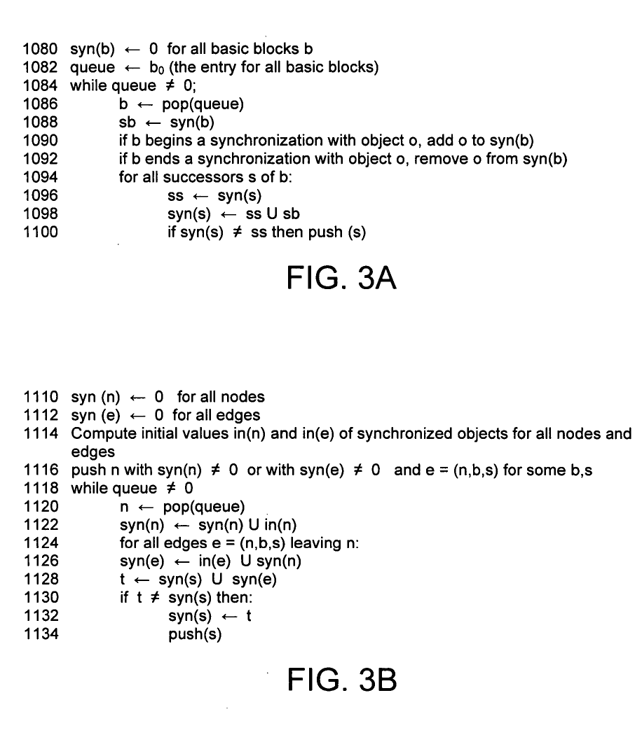

FIGS. 3A-B show an example of pseudo-code for identifying synchronized objects for each basic block, each node and each edge of the invocation graph in step 108. So, in FIG. 3A a block synchronization variable (syn(b)) is initialized in 1080 for all basic blocks. Then, basic block entry points are queued in 1082. After initialization, a fixed point iteration begins in 1084 to refine the synchronization variable for each block, block by block, i.e., until the blocks no longer are found in the queue. As each block is popped from the queue in 1086, the current value of the set of synchronization objects is saved in 1088, and then the set is updated whenever a synchronization begins 1090 or ends at that point 1092. The value of any objects that begin synchronization with the block are added to the synchronization variable value and the value of those objects that end synchronization with the block is removed. This continues until the node synchronization variable value reaches a steady-state, i.e., does not change. Thus, 1094-1098 values for successors are added iteratively as long as the synchronization value is found to have changed in 1100.

In FIG. 3B a node synchronization variable (syn(n)) is cleared in 1110 for all nodes; and, an edge synchronization variable (syn(n)) is cleared in 1112 for all edges. Then, initial node and edge values are determined for synchronized objects for all nodes and edges in 1114. All nodes with some degree of synchronization, either in the node itself or in adjacent edges are queued in 1116. As long as the queue is not empty 1118, for each node popped from the queue in 1120, the current value of its synchronization object set is augmented with the initial values already found for that node in 1122. Then for all edges leaving that node in 1124, the edge's synchronization object set is determined in 1126 as the union of the initial values and the predecessor node's set. The elements from the edge's synchronization object set is added to the successor node's synchronization object set in 1128. If the successor node's synchronization object set changes in 1130, then in 1132 the edge's synchronization object set is replaced with the updated object set and the successor node is returned back to the queue. Again, this continues until a final synchronization value is reached in 1134, i.e., at steady-state, and therefore, any synchronized objects for each node and edge have been identified.

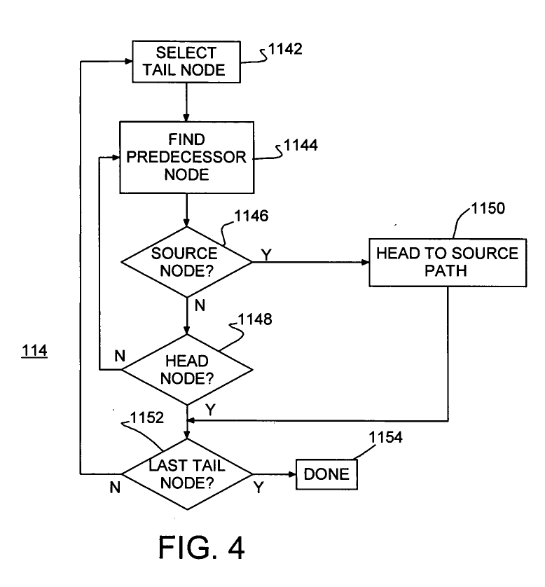

FIG. 4 shows a flow diagram example in more detail of the step of finding head to tail paths through sources in step 114 of FIG. 1, locating paths from heads to sources, i.e., a path from source to tail is concatenated with a path from head to source to yield a path from head to tail through a source. So, in step 1142, a tail node is selected, and in step 1144 a predecessor node is found. In step 1146, the predecessor node is checked to determine if it is a source node. If it is not a source node, in step 1148 it is checked to determine whether it is a head node. If not, then, returning to step 1144 the next predecessor node is found. If in step 1146, the current (predecessor) node is a source node, then in step 1150, the path(s) from each head node to the current (predecessor) node is determined and identified as having containing a source node. If in step 1148 the current node is not a head node or the path is identified in step 1150, then in step 1152, the identified tail nodes are checked to determine if all have been selected. If any tail node remain unselected, then returning to step 1142, another tail node is selected. When no tail nodes remain unselected in step 1152, all source node paths have been identified in step 1154.

Advantageously, computer programs that support synchronization of threads of execution may be managed and modified according to the present invention to minimize unwanted synchronization. Synchronization nodes are identified, and a determination is made whether synchronization is in fact necessary, or if the particular program code may be restructured, even automatically, to make each unnecessary. Synchronization of expensive or dangerous thread operations may be avoided or eliminated. Any synchronization found to be unnecessary may simply be eliminated, and necessary synchronization eliminated where appropriate through code restructuring, either manually, e.g., by a user/developer, or by a transformation program, for a significant performance improvement and a more stable system. Furthermore, as described herein, the present invention may be implemented on any suitable typical computer or personal computer (PC), e.g., 105 in FIG. 1.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A method of minimizing unwanted synchronizations in a multithreading program, comprising:
a) identifying program functions in a multithreading program that should not be synchronized as input tails;
b) constructing an invocation graph having a plurality of nodes, each corresponding to code functions of said multithreading program, said plurality of nodes including head nodes and tail nodes corresponding to said input tails;
c) determining synchronization information for each node of said invocation graph, ones of said plurality of nodes representing sources of synchronization in said invocation graph, said ones being identified as source nodes; and
d) finding all paths from head nodes to tail nodes through at least one source node.

2. A method as in claim 1, wherein said head node identified in the step (b) of constructing the invocation graph identifies entry points into the multithreading program are identified as head nodes.

3. A method as in claim 1, wherein the step (c) of determining synchronization information, comprises:
i) selecting a code block from said multithreading program;
ii) identifying all objects beginning and ending synchronization at the selected said code block;
iii) finding all successors to said code block; and until no successors for said code block are found; and
iv) expanding said block to include said successors and returning to step (ii).

4. A method as in claim 3, wherein when no successors are found in step (iii), step (c) comprises returning to step (i) until all code blocks have been selected.

5. A method as in claim 1, wherein the step (c) of determining synchronization information, comprises:
i) initializing synchronization variables for each node and each edge of said invocation graph;
ii) determining initial synchronization values for said each node and said each edge;
iii) selecting a source node;
iv) increasing the synchronization value for the selected source node by the value of any attached edge; and until no attached edge is found; and
v) expanding the neighborhood of the selected source node to include nodes connected to attached edges, and treating the expanded neighborhood as the source node, returning to step (iv).

6. A method as in claim 5, wherein when no edges are found in step (iv), step (c) comprises returning to step (iii) until all source nodes have been selected.

7. A method as in claim 1, wherein the step (c) of determining synchronization information identifies each synchronization as necessary or unnecessary.

8. A method as in claim 7, wherein unnecessary synchronizations are identified as those synchronizations that do not change multithreading program performance by inclusion or omission, necessary synchronizations being all remaining said synchronizations.

9. The method of claim 1, wherein the step (c) of determining synchronization information identifies each synchronization as wanted or unwanted.

10. A method as in claim 9, wherein unwanted synchronizations are identified as those synchronizations that degrade multithreading program performance.

11. A method as in claim 1, wherein said input tails are identified manually in the step (a).

12. A computer program product for minimizing unwanted synchronizations in a multithreading program, said computer program product comprising a computer usable medium having computer readable program code thereon, said computer readable program code comprising:
computer readable program code means for identifying program functions in a multithreading program as input tails, said input tails being functions that should not be synchronized;
computer readable program code means for constructing an invocation graph having a plurality of nodes, each corresponding to code functions of said multithreading program, said plurality of nodes including head nodes and tail nodes corresponding to said input tails;
computer readable program code means for determining synchronization information for objects in said multithreading program, ones of said plurality of nodes representing sources of synchronization in said invocation graph, said ones being identified as source nodes; and
computer readable program code means for finding all paths from head nodes to tail nodes through at least one source node.

13. A computer program product as in claim 12, wherein the computer readable program code means for constructing the invocation graph automatically identifies entry points into the multithreading program as head nodes.

14. A computer program product as in claim 12, wherein the computer readable program code means for determining synchronization information comprises:
computer readable program code means for selecting a code block from said multithreading program;
computer readable program code means for identifying all said objects beginning and ending synchronization at the selected said code block;
computer readable program code means for finding all successors to said code block; and
computer readable program code means for expanding said block to include said successors and until no successors are found for said code block.

15. A computer program product as in claim 12, wherein the computer readable program code means for determining synchronization information comprises:
computer readable program code means for initializing synchronization variables for each node and each edge of said invocation graph;
computer readable program code means for determining initial synchronization values for said each node and said each edge;
computer readable program code means for selecting a source node;
computer readable program code means for increasing the synchronization value for the selected source node by the value of any attached edge; and
computer readable program code means for expanding the neighborhood of the selected source node to include nodes connected to attached edges, and treating the expanded neighborhood as the source node until no attached edges are found.

16. A computer program product as in claim 12, wherein the computer readable program code means for determining synchronization information comprises:
computer readable program code means for identifying those synchronizations that do not change multithreading program performance by inclusion or omission as necessary synchronizations and all remaining said synchronizations unnecessary; and
computer readable program code means for identifying those necessary synchronizations that degrade multithreading program performance as being unwanted synchronizations.

17. A system for minimizing unwanted synchronizations in a multithreading program comprising:
means for identifying program functions in a multithreading program as input tails, said input tails being functions that should not be synchronized;
means for constructing an invocation graph having a plurality of nodes, each corresponding to code functions of said multithreading program, head nodes being automatically identified in said plurality of nodes and tail nodes corresponding to said input tails;
means for determining synchronization information for objects in said multithreading program, ones of said plurality of nodes representing sources of synchronization in said invocation graph, said ones being identified as source nodes; and
means for finding all paths from head nodes to tail nodes through at least one source node.

18. A system as in claim 17, wherein the means for determining synchronization information comprises:
means for selecting a code block from said multithreading program;
means for identifying all said objects beginning and ending synchronization at the selected said code block;
means for finding all successors to said code block; and
means for expanding said block to include said successors and until no successors are found for said code block.

19. A system as in claim 17, wherein the determining synchronization information further comprises:
means for initializing synchronization variables for each node and each edge of said invocation graph;
means for determining initial synchronization values for said each node and said each edge;
means for selecting a source node;
means for increasing the synchronization value for the selected source node by the value of any attached edge; and
means for expanding the neighborhood of the selected source node to include nodes connected to attached edges, and treating the expanded neighborhood as the source node until no attached edges are found.

20. A system as in claim 19, wherein the means for determining synchronization information further comprises:
means for identifying those synchronizations that do not change multithreading program performance by inclusion or omission as necessary synchronizations and all remaining said synchronizations unnecessary; and
means for identifying those necessary synchronizations that degrade multithreading program performance as being unwanted synchronizations.
